(19) United States
(12) Patent Application Publication
(10) Pub. No.: US 2024/0166055 A1
(43) Pub. Date: May 23, 2024

(54) BRAKING CONTROL DEVICE FOR VEHICLE

(71) Applicant: ADVICS CO., LTD., Kariya-shi (JP)

(72) Inventors: Masaki MARUYAMA, Kariya-shi (JP); Takayuki YAMAMOTO, Kariya-shi (JP)

(73) Assignee: ADVICS CO., LTD., Kariya-shi (JP)

(21) Appl. No.: 18/551,677

(22) PCT Filed: Mar. 22, 2022
(86) PCT No.: PCT/JP2022/013006

§ 371 Date: Sep. 21, 2023

(30) Foreign Application Priority Data
Mar. 22, 2021 (JP) 2021-046767

(51) Int. Cl. B60L 7/26

(52) U.S. Cl. CPC B60L 7/26

(57) ABSTRACT

Front and rear wheel required braking forces are calculated so that a braking force required as a whole of the vehicle matches the sum of the front and rear wheel required braking forces, and a ratio of the rear wheel required braking force to the front wheel required braking force is constant. When the front and rear wheel required braking forces are equal to or less than the maximum front and rear wheel regenerative braking forces, the front and rear wheel required braking forces are achieved only by the front and rear wheel regenerative braking forces. When the front and rear wheel required braking forces are larger than the maximum front and rear wheel regenerative braking forces, the front and rear wheel required braking forces are achieved by the front and rear wheel regenerative braking forces and the front and rear wheel frictional braking forces.

### TECHNICAL FIELD

The present disclosure relates to a braking control device for a vehicle.

### BACKGROUND ART

Patent Literature 1 describes that “in a first stage in which regenerative braking force for one or more of the front wheels and the rear wheels is generated up to a reference deceleration and the braking forces for the front wheels and the rear wheels are distributed at the time of braking, after the front and rear wheel regenerative braking forces are distributed and generated by a reference braking distribution ratio, only the rear wheel regenerative braking force is generated up to the limit value of the rear wheel regenerative braking force; if the rear wheel regenerative braking force increases up to the limit value of the rear wheel regenerative braking force, the proportion of the front wheel braking force is then increased; if the rear wheel regenerative braking force increases up to the limit value of the rear wheel regenerative braking force, only the front wheel fluid braking force is then generated and the proportion of the front wheel braking force is increased; if the proportion of the front wheel braking force increases and the distribution ratio between the front wheel braking force and the rear wheel braking force becomes the reference braking distribution ratio, the rear wheel regenerative braking force is then generated up to the maximum value of the rear wheel regenerative braking force” for the purpose of “providing a braking force control method at the time of regenerative braking coordination control for securing safety of braking system for independently controlling braking force of front wheel and rear wheel, improving fuel consumption, and distributing excellent braking force”.

The applicant has developed a braking control device as described in Patent Literature 2 in order to achieve regenerative coordination control wherein both vehicle stability and energy regeneration are achieved at a high level. Patent Literature 2 describes independent control (a control independent of the brake fluid pressure of the front wheel system and the brake fluid pressure of the rear wheel system) in a case where front and rear wheel regenerative generators GNf and GNr are provided on the front and rear wheels.

However, from the viewpoint of directional stability when the vehicle is braked, it is preferable that the relationship between the front wheel braking force and the rear wheel braking force is constant. That is, it is preferable that, even during the regenerative braking in which the regenerative braking device generates the regenerative braking force, the distribution adjustment of the front and rear wheel braking forces is performed according to the reference property (“basic braking distribution line” in Patent Literature 1, and reference property Cb in Patent Literature 2) in which the ratio of the rear wheel braking force to the front wheel braking force is constant. However, in Patent Literatures 1 and 2, the actual characteristics of the front and rear wheel braking forces deviate from the reference property during regenerative braking (see FIG. 6 of Patent Literature 1 and FIG. 7 of Patent Literature 2).

### CITATIONS LIST

### Patent Literature

Patent Literature 1: JP 2017-052502 A
Patent Literature 2: JP 2019-059296 A

### BRIEF SUMMARY

### Technical Problems

An object of the present disclosure is to provide a braking control device applied to a vehicle including regenerative braking devices on front and rear wheels, in which a front and rear wheel braking force distribution can be appropriately adjusted during regenerative braking.

### Solutions to Problems

The braking control device for a vehicle according to the present disclosure is applied to a vehicle including front and rear wheel regenerative braking devices (KCf, KCr) that generate front and rear wheel regenerative braking forces (Fgf, Fgr) in front and rear wheels (WHf, WHr), including “an actuator (HU) that generates front and rear wheel frictional braking forces (Fmf, Fmr) in the front and rear wheels (WHf, WHr)” and “a controller (ECU) that controls the front and rear wheel regenerative braking devices (KCf, KCr) and the actuator (HU)”.

In the braking control device for a vehicle according to the present disclosure, the controller (ECU) calculates the braking force required for the vehicle as a whole as target vehicle body braking force (Fv), and calculates front and rear wheel required braking forces (Fqf, Fqr) so that the sum of the front and rear wheel required braking forces (Fqf, Fqr) matches the target vehicle body braking force (Fv) and the ratio (Kq) of the rear wheel required braking force (Fqr) to the front wheel required braking force (Fqf) is constant (value hb) (that is, “Fv=Fqf+Fqr” and “Fqr/Fqf=hb”). Further, the controller (ECU) acquires maximum values of the front and rear wheel regenerative braking forces (Fgf, Fgr), which can be generated and are determined by the operation states of the front and rear wheel regenerative braking devices (KCf, KCr), as the maximum front and rear wheel regenerative braking forces (Fxf, Fxr). Then, the controller (ECU) achieves the front wheel required braking force (Fqf) only by the front wheel regenerative braking force (Fgf) when the front wheel required braking force (Fqf) is equal to or less than the maximum front wheel regenerative braking force (Fxf) (Fqf≤Fxf), and achieves the front wheel required braking force (Fqf) by the front wheel regenerative braking force (Fgf) and the front wheel friction braking force (Fmf) when the front wheel required braking force (Fqf) is larger than the maximum front wheel regenerative braking force (Fxf) (Fqf>Fxf). In addition, when the rear wheel required braking force (Fqr) is equal to or less than maximum rear wheel regenerative braking force (Fxr) (Fqr≤Fxr), the rear wheel required braking force (Fqr) is achieved only by the rear wheel regenerative braking force (Fgr), and when the rear wheel required braking force (Fqr) is larger than maximum rear wheel regenerative braking force (Fxr) (Fqr>Fxr), the rear wheel required braking force (Fqr) is achieved by the rear wheel regenerative braking force (Fgr) and the rear wheel friction braking force (Fmr).

According to the above configuration, since the front and rear wheel regenerative braking forces Fgf and Fgr and the front and rear wheel frictional braking forces Fmf and Fmr are adjusted so that the ratio Kq of the rear wheel required braking force For to the front wheel required braking force Fqf is always constant (value hb), the front and rear wheel braking force distribution during the regenerative braking is always optimized. In addition, since the front and rear wheel regenerative braking devices KCf and KCr regenerate the kinetic energy of the vehicle to the maximum within the range up to the maximum front and rear wheel regenerative braking forces Fxf and Fxr, the directional stability of the vehicle and the energy regeneration are simultaneously achieved as appropriate.

### BRIEF DESCRIPTION OF DRAWINGS

FIG. 1 is a configuration diagram for describing an entirety of a vehicle JV mounted with a braking control device SC.

FIG. 2 is a flowchart for describing a process of regenerative coordination control.

FIG. 3 is a characteristic diagram for describing the front and rear wheel braking force distribution in the regenerative coordination control at the start of braking.

FIG. 4 is a characteristic diagram for describing the front and rear wheel braking force distribution at the time of the switching operation of the regenerative coordination control.

### DESCRIPTION OF EMBODIMENTS

<Symbols of Components>

In the description below, components such as members, signals, and values, denoted by the same symbol, like “CW” or the like, have the same function. The suffixes “f” and “r” attached to the end of various symbols related to the wheels are comprehensive symbols indicating elements related to certain aspects of either the front wheels or the rear wheels. Specifically, “f” indicates “an element related to the front wheel”, and “r” indicates “an element related to the rear wheel”. For example, in the wheel cylinder CW, it is described as “front wheel cylinder CWf, rear wheel cylinder CWr”. Further, the suffixes “f” and “r” may be omitted. When these are omitted, each symbol indicates a generic name thereof.

<Vehicle JV Mounted with Braking Control Device SC>

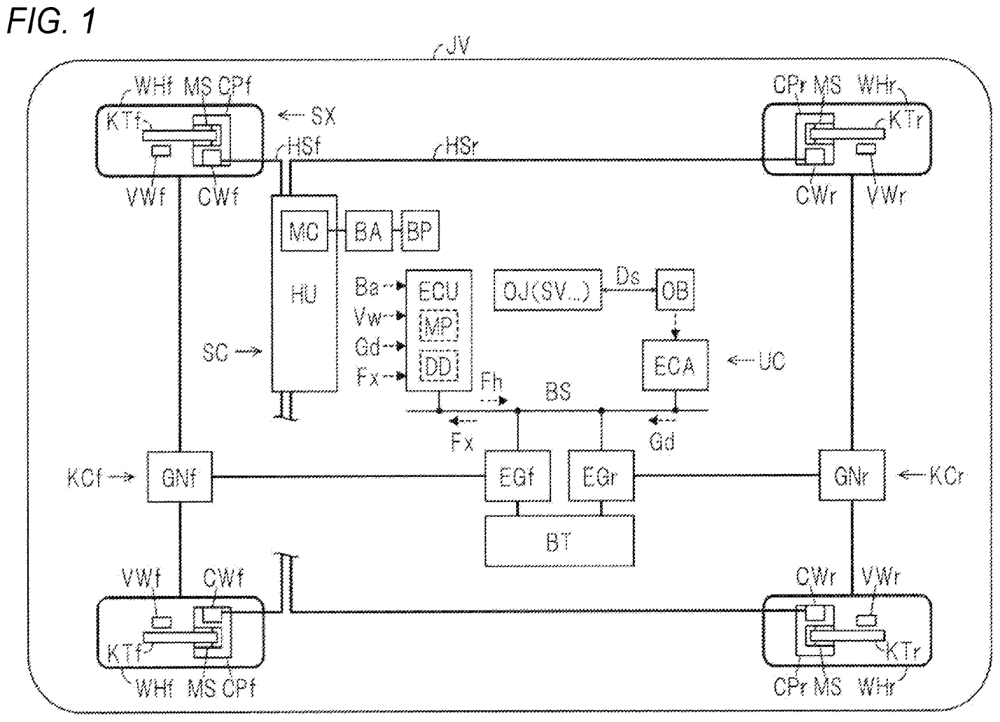

An entirety of a vehicle mounted with a braking control device SC according to the present disclosure will be described with reference to the configuration diagram of FIG. 1. Here, the vehicle mounted with the braking control device SC is also referred to as a “current vehicle JV” in order to be distinguished from other vehicles (for example, a preceding vehicle SV).

The vehicle JV is a hybrid vehicle or an electric vehicle including a driving electric motor GN. The driving electric motor GN also functions as a generator for energy regeneration. The generator GN is provided on front wheels WHf and rear wheels WHr. The front and rear wheel generators GNf and GNr (=GN) are controlled (driven) by generator controllers EGf and EGr. Here, a device including the front wheel generator GNf and the controller EGf thereof is referred to as a “front wheel regenerative braking device KCf”. In addition, a device including the rear wheel generator GNr and the controller EGr thereof is referred to as a “rear wheel regenerative braking device KCr”. The vehicle JV includes storage batteries BT for the front and rear wheel regenerative braking devices KCf and KCr. That is, the front and rear wheel regenerative braking devices KCf and KCr also include storage batteries BT.

When the electric motor/generator GN(=GNf, GNr) operates as an driving electric motor (at the time of acceleration of the vehicle JV), electric power is supplied from the storage battery BT to the electric motor/generator GN via the controller EG for the regenerative braking device (also simply referred to as a “regenerative controller”). On the other hand, when the electric motor/generator GN operates as a generator (when the vehicle JV decelerates), the electric power from the generator GN is stored in the storage battery BT via the regenerative controller EG (That is, regenerative braking is performed). In the regenerative braking, the front and rear wheel regenerative braking forces Fgf and Fgr are independently and individually generated by the front and rear wheel generators GNf and GNr.

The vehicle JV includes a braking device SX. The braking device SX generates front and rear wheel frictional braking forces Fmf and Fmr on the front wheel WHf and the rear wheel WHr. The braking device SX includes a rotating member (for example, a brake disc) KT and a brake caliper CP. The rotating member KT is fixed to the wheel WH, and the brake caliper CP is provided to sandwich the rotating member KT. The brake caliper CP is provided with a wheel cylinder CW. Brake fluid BF adjusted to a brake fluid pressure Pw is supplied from the braking control device SC to the wheel cylinder CW. A friction member (for example, a brake pad) MS is pressed against the rotating member KT by the brake fluid pressure Pw. Since the rotating member KT and the wheel WH are fixed to rotate integrally, a frictional braking force Fm is generated on the wheel WH by the frictional force generated at this time.

The vehicle JV includes a braking operation member BP and various sensors (BA and the like). The braking operation member (for example, a brake pedal) BP is a member operated by the driver to decelerate the vehicle. The vehicle JV is provided with a braking operation amount sensor BA that detects an operation amount (braking operation amount) Ba of the braking operation member BP. As the braking operation amount sensor BA, at least one of a master cylinder fluid pressure sensor PM that detects a fluid pressure (master cylinder fluid pressure) Pm in the master cylinder CM, an operation displacement sensor SP that detects an operation displacement Sp of the braking operation member BP, and an operation force sensor FP that detects an operation force Fp of the braking operation member BP is adopted. That is, at least one of the master cylinder fluid pressure Pm, the braking operation displacement Sp, and the braking operation force Fp is detected as the braking operation amount Ba by the operation amount sensor BA. The braking operation amount Ba is input to a controller ECU for the braking control device SC (also simply referred to as a “braking controller”). The vehicle JV includes various sensors including a wheel speed sensor VW that detects the rotational speed (wheel speed) Vw of the wheel WH. Detection signals (Ba and the like) of these sensors are input to the braking controller ECU. In the braking controller ECU, a vehicle body speed Vx is calculated based on the wheel speed Vw.

The vehicle JV includes a braking control device SC to execute so-called regenerative coordination control (control to coordinate and operate the regenerative braking force Fg and the friction braking force Fm). In the braking control device SC, a so-called front-rear type (also referred to as “type II”) is adopted as a two-system brake system. The braking control device SC adjusts the actual brake fluid pressure Pw according to the operation amount Ba of the braking operation member BP, and supplies the brake fluid pressure Pw to the braking device SX (In particular, the wheel cylinder CW) via front and rear wheel communication paths HSf and HSr. The braking control device SC includes a fluid unit HU (also referred to as an “actuator”) including the master cylinder CM and a controller ECU (braking controller) for the braking control device SC.

For example, as described in JP 2008-006893 A, a fluid unit in which the fluid pressures (brake fluid pressures) Pw of all the wheel cylinders CW can be independently and individually controlled is adopted as the fluid unit HU (actuator). Further, as described in JP 2018-047807 A, the fluid pressure Pw of the wheel cylinder CW of the front and rear wheels which can be independently and individually controlled may be adopted. That is, in the fluid unit HU, at least the front wheel brake fluid pressure Pwf and the rear wheel brake fluid pressure Pwr are independently and individually controlled.

The fluid unit HU (electromagnetic valve, electric motor, or the like) is controlled by the braking controller ECU. The controller ECU for the braking control device SC includes a microprocessor MP that performs signal processing, and a drive circuit DD that drives electromagnetic valves and electric motors. The braking controller ECU, the controller EG (=EGf, EGr) for the regenerative braking device, and a controller ECA (to be described later) for the driving assistance device are respectively connected to a communication bus BS. Therefore, information (detection value, calculation value) is shared between these controllers via the communication bus BS. For example, the vehicle body speed Vx is calculated by the braking controller ECU and transmitted to the controller ECA for the driving assistance device (also simply referred to as a “driving assistance controller”) via the communication bus BS. Target deceleration Gd is calculated by the driving assistance controller ECA and transmitted to the braking controller ECU via the communication bus BS. Target regenerative braking forces Fh (=Fhf, Fhr) (to be described later) is calculated by the braking controller ECU and transmitted to the regenerative controller EG (=EGf, EGr) via the communication bus BS. The maximum regenerative braking force Fx (=Fxf, Fxr) (to be described later) is calculated by the regenerative controller EG (=EGf, EGr) and transmitted to the braking controller ECU via the communication bus BS. The braking operation amount Ba, the wheel speed Vw, the target deceleration Gd, the maximum regenerative braking force Fx, and the like are input to the braking controller ECU. The fluid unit HU is controlled by the braking controller ECU based on these signals.

The vehicle JV is provided with a driving assistance device UC that performs automatic braking instead of or to assist the driver. The driving assistance device UC includes an object detection sensor OB that detects a distance Ds (relative distance) to an object OJ (including a preceding vehicle SV traveling in front of the current vehicle JV) in front of the current vehicle JV, and a controller ECA for the driving assistance device. For example, a radar sensor, a millimeter wave sensor, an image sensor, or the like is adopted as the object detection sensor OB. The driving assistance controller ECA calculates the target deceleration Gd of the current vehicle JV (the target value of the vehicle body acceleration in the front-rear direction of the current vehicle JV) based on a detection result Ds (relative distance) of the object detection sensor OB. The target deceleration Gd (the target front-rear acceleration of the vehicle body) is transmitted from the driving assistance controller ECA to the braking controller ECU via the communication bus BS. Then, the braking control device SC generates the braking forces Fg and Fm according to the target deceleration Gd.

<Processing of Regenerative Coordination Control>

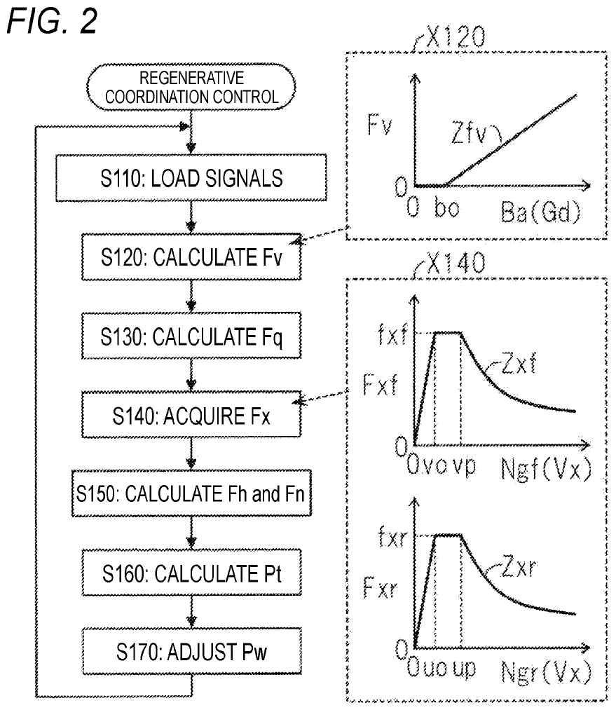

The processing of the regenerative coordination control will be described with reference to the flowchart of FIG. 2. The “regenerative coordination control” is to coordinate and control the regenerative braking force Fg by the generator GN and the friction braking force Fm by the braking control device SC so that kinetic energy of the vehicle JV is efficiently recovered (regenerated) as electric energy at the time of braking. The algorithm of the regenerative coordination control is programmed in the microprocessor MP of the braking controller ECU. In the regenerative coordination control, the regenerative braking force Fg and the friction braking force Fm can be adjusted independently and individually between the front and rear wheels.

In step S110, signals such as the braking operation amount Ba, the brake fluid pressure Pw, the vehicle body speed Vx, and the target deceleration Gd are loaded. The operation amount Ba is calculated based on a detection value of the operation amount sensor BA (master cylinder fluid pressure sensor, operation displacement sensor, operation force sensor, and the like). The brake fluid pressure Pw is calculated based on a detection value of a fluid pressure sensor PW (not illustrated) provided in the fluid unit HU. The vehicle body speed Vx is calculated based on the wheel speed Vw (detection value of the wheel speed sensor VW). The target deceleration Gd is transmitted from the driving assistance controller ECA.

In step S120, the target vehicle body braking force Fv is calculated based on the braking operation amount Ba. The “target vehicle body braking force Fv” is a target value corresponding to the braking force Fb acting on the vehicle body (that is, the braking force of the vehicle JV as a whole). The target vehicle body braking force Fv is calculated as “0” when the braking operation amount Ba is less than a predetermined amount bo based on the braking operation amount Ba and a calculation map Zfv. Then, when the braking operation amount Ba is equal to or higher than the predetermined amount bo, the target vehicle body braking force Fv is calculated as increasing from “0” along with the increase of the braking operation amount Ba from “0”. Here, the predetermined amount bo is a predetermined default value (constant) representing a play of the braking operation member BP.

When the braking is automatically performed by the driving assistance device UC (that is, in the case of automatic braking control independent of the operation of the braking operation member BP), the target vehicle body braking force Fv is calculated based on the target deceleration Gd in step S120 as in the case of the braking operation amount Ba. Specifically, the target vehicle body braking force Fv is calculated as “0” when “Gd<bo”, and is calculated as increasing from “0” along with the increase in the target deceleration Gd when “Gd≥ bo”. Here, the predetermined amount bo is a predetermined default value (constant) representing a dead zone in the automatic braking control.

In step S130, the front and rear wheel required braking forces Fqf and Fqr (=Fq) are calculated based on the target vehicle body braking force Fv. The “front and rear wheel required braking forces Fqf, Fqr” are target values corresponding to the actual front and rear wheel braking forces Fbf and Fbr acting on the front wheel WHf and the rear wheel WHr. Therefore, the braking force requirement Fq is a target value corresponding to the sum of the regenerative braking force Fg and the friction braking force Fm. Since the braking forces of the left and right wheels are calculated as the same value in the braking control device SC, the front wheel required braking force Fqf corresponds to the amount of two wheels in the front of the vehicle (that is, the front two wheels WHf), and the rear wheel required braking force For corresponds to the amount of two wheels in the rear of the vehicle (that is, the rear two wheels WHr). In step S130, the front and rear wheel required braking forces Fqf and Fqr are calculated so that the following two conditions are satisfied.

Condition 1: A sum of the front wheel required braking force Fqf and the rear wheel required braking force Fqr matches the target vehicle body braking force Fv (that is, “Fv=Fqf+Fqr”).

Condition 2: The ratio Kq of the rear wheel required braking force Fqr to the front wheel required braking force Fqf is constant (value hb) (that is, “Kq=Fqr/Fqf=hb, where hb is a predetermined default value (constant)”).

Specifically, in step S130, assuming the ratio Kq as “hb (constant value)”, the front and rear wheel required braking forces Fqf and Fqr are calculated as in the following equation (1).

Fqf=Fv/(1+hb), and Fqr=Fv·hb/(1+hb) Equation (1)

In step S140, the maximum front and rear wheel regenerative braking forces Fxf and Fxr (=Fx) are acquired. The “maximum regenerative braking force Fx” is the maximum value (limit value) of the front and rear wheel regenerative braking forces Fgf and Fgr that can be generated by the front and rear wheel regenerative braking devices KCf and KCr (=KC). In other words, the maximum regenerative braking force Fx is a state quantity representing the limit of the regenerative braking force Fg.

The maximum regenerative braking force Fx is restricted by the operation state of the regenerative braking device KC. Therefore, the maximum regenerative braking force Fx is determined based on the operation state of the regenerative braking device KC. Specifically, the operation state of the regenerative braking device KC corresponds to at least one of the rotational speed Ng of the generator GN (that is, the front and rear wheel rotational speeds Ngf and Ngr), the state (temperature or the like) of the regenerative controller EG (in particular, a power transistor such as an IGBT), and the state of the storage battery BT (charge reception amount, temperature, or the like). The maximum regenerative braking force Fx is calculated (determined) by the regenerative controller EG and acquired by the braking controller ECU via the communication bus BS. For example, in the regeneration controller EG, the maximum regenerative braking force Fx is determined by the following method.

The maximum front wheel regenerative braking force Fxf (upper limit value of the front wheel regenerative braking force) is determined based on a characteristic Zxf (calculation map) in the upper stage of a block X140. This is because the regeneration amount (resultantly, regenerative braking force) by the regenerative braking device KC is determined by the rating of the power transistor (IGBT or the like) of the regeneration controller EG and the charge acceptance amount of the storage battery BT (the remaining amount obtained by subtracting the current charge amount from the full charge amount). Specifically, in the calculation map Zxf, when the rotation speed Ngf of the front wheel generator GNf (also simply referred to as “front wheel rotation speed”) is equal to or higher than a first front wheel predetermined speed vp, the maximum regenerative braking force Fx is determined so that the regenerative power (power) of the front wheel regenerative braking device KCf is constant (that is, the product of the maximum regenerative braking force Fx and the front wheel rotation speed Ngf is constant). Therefore, when “Ngf≥vp”, the maximum regenerative braking force Fx is calculated as increasing in an inversely proportional relationship with respect to the rotation speed Ngf as the front wheel rotation speed Ngf decreases. In addition, since the regeneration amount decreases when the front wheel rotation speed Ngf decreases, in the calculation map Zxf, when the front wheel rotation speed Ngf is less than a second front wheel predetermined speed vo, the maximum front wheel regenerative braking force Fxf is calculated as decreasing along with the decrease of the rotation speed Ngf. Furthermore, a predetermined front wheel upper limit value fxf is provided in the calculation map Zxf so that an excessive deceleration slip (in extreme cases, wheel lock) does not occur in the front wheel WHf by the front wheel regenerative braking force Fgf. Note that, the first front wheel predetermined speed vp, the second front wheel predetermined speed vo, and the front wheel upper limit value fxf are predetermined default values (constants).

Similarly as the maximum front wheel regenerative braking force Fxf, maximum rear wheel regenerative braking force Fxr (upper limit value of the rear wheel regenerative braking force) is determined based on the characteristic Zxr (calculation map) in the lower stage of the block X140. Specifically, in the calculation map Zxr, when the rotation speed Ngr of the rear wheel generator GNr (also simply referred to as “rear wheel rotation speed”) is equal to or higher than a first rear wheel predetermined speed up, the maximum regenerative braking force Fx is determined so that the regenerative power (power) of the rear wheel regenerative braking device KCr is constant (that is, the product of the maximum regenerative braking force Fx and the rear wheel rotation speed Ngr is constant). Therefore, when “Ngr≥ up”, the maximum regenerative braking force Fx is calculated as increasing in an inversely proportional relationship with respect to the rotation speed Ngr as the rear wheel rotation speed Ngr decreases. In addition, since the regeneration amount decreases when the rear wheel rotation speed Ngr decreases, in the calculation map Zxr, when the rear wheel rotation speed Ngr is less than a second rear wheel predetermined speed uo, maximum rear wheel regenerative braking force Fxr is calculated as decreasing along with the decrease of the rotation speed Ngr. Furthermore, a predetermined rear wheel upper limit value fxr is provided in the calculation map Zxr so that an excessive deceleration slip (in extreme cases, wheel lock) does not occur in the rear wheel WHr by the rear wheel regenerative braking force Fgr. Note that, the first rear wheel predetermined speed up, the second rear wheel predetermined speed uo, and the rear wheel upper limit value fxr are predetermined default values (constants).

The method for determining the maximum front and rear wheel regenerative braking forces Fxf and Fxr (=Fx) based on the front and rear wheel rotation speeds Ngf and Ngr (=Ng) in each generator GN has been described above. Further, the maximum regenerative braking force Fx is determined based on the state, such as temperature, of the regenerative controller EG. When the temperature of the regeneration controller EG is high, the maximum regenerative braking force Fx is determined to further decrease from the maximum regenerative braking force Fx determined according to the rotation speed Ng. In addition, when the temperature of the storage battery BT is high, the maximum regenerative braking force Fx is calculated as decreasing.

In step S150, the front and rear wheel target regenerative braking forces Fhf and Fhr and the front and rear wheel target friction braking forces Fnf and Fnr are calculated based on the front and rear wheel required braking forces Fqf and For and the maximum front and rear wheel regenerative braking forces Fxf and Fxr. The “front and rear wheel target regenerative braking forces Fhf and Fhr (=Fh)” are target values corresponding to the actual front and rear wheel regenerative braking forces Fgf and Fgr (=Fg) to be achieved by the front and rear wheel regenerative braking devices KCf and KCr. In addition, the “front and rear wheel target friction braking forces Fnf and Fnr (=Fn)” are target values corresponding to the actual front and rear wheel frictional braking forces Fmf and Fmr (=Fm) to be achieved by the braking control device SC.

In step S150, “whether or not the front wheel required braking force Fqf is larger than the maximum front wheel regenerative braking force Fxf (referred to as “front wheel limit determination”)”is determined. When the front wheel required braking force Fgf is equal to or less than the maximum front wheel regenerative braking force Fxf (that is, when “Fqf≤Fxf” and the front wheel limit determination is negative), the front wheel target regenerative braking force Fhf is calculated as the front wheel required braking force Fqf, and the front wheel target friction braking force Fnf is calculated as “0” (that is, “Fhf=Fqf, Fnf=0”). On the other hand, when the front wheel required braking force Fqf is larger than the maximum front wheel regenerative braking force Fxf (that is, when “Fgf>Fxf” and the front wheel limit determination is affirmative), the front wheel target regenerative braking force Fhf is calculated as the maximum front wheel regenerative braking force Fxf, and the front wheel target friction braking force Fnf is calculated as a value subtracting the maximum front wheel regenerative braking force Fxf from the front wheel required braking force Fqf (that is, “Fhf=Fxf, Fnf=Fqf−Fxf”).

Similarly as the calculation related to the front wheel WHf, and the like, in step S150, “whether or not the rear wheel required braking force For is larger than the maximum rear wheel regenerative braking force Fxr (referred to as “rear wheel limit determination”)”is determined. When the rear wheel required braking force For is equal to or less than the maximum rear wheel regenerative braking force Fxr (that is, when “Fqr≤Fxr” and the rear wheel limit determination is negative), the rear wheel target regenerative braking force Fhr is calculated as the rear wheel required braking force For, and the rear wheel target friction braking force For is calculated as “0” (that is, “Fhr=Fqr, Fnr=0”). On the other hand, when the rear wheel required braking force For is larger than the maximum rear wheel regenerative braking force Fxr (that is, when “Fqr>Fxr” and the rear wheel limit determination is affirmative), the rear wheel target regenerative braking force Fhr is calculated as the maximum rear wheel regenerative braking force Fxr, and the rear wheel target friction braking force Fnr is calculated as a value subtracting the maximum rear wheel regenerative braking force Fxr from the rear wheel required braking force Fqr (that is, “Fhr=Fxr, Fnr=Fqr−Fxr”). The front wheel limit determination and the rear wheel limit determination are individually performed respectively.

The rear wheel target regenerative braking force Fhf and Fhr calculated in the step S150 are transmitted from the braking controller ECU to the front and rear wheel regenerative controller EGf and EGr. Then, the front and rear wheel generators GNf and GNr are controlled by the front and rear wheel regenerative controllers EGf and EGr so that the actual front and rear wheel regenerative braking forces Fgf and Fgr approach and match the front and rear wheel target regenerative braking forces Fhf and Fhr.

In step S160, the front and rear wheel target fluid pressures Ptf and Ptr are calculated based on the front and rear wheel target friction braking forces Fnf and Fnr. The “font/rear wheel target fluid pressures Ptf, Ptr (=Pt)” are target values corresponding to the actual front and rear wheel brake fluid pressures Pwf, Pwr (=Pw). Specifically, the target friction braking force Fn is converted to the target fluid pressure Pt based on the specifications (pressure receiving area of wheel cylinder CW, effective braking radius of rotating member KT, friction coefficient of friction member MS, effective radius of wheel (tire), and the like) of the braking device SX and the like.

In step S170, the front and rear wheel brake fluid pressures Pwf and Pwr (actual values) are adjusted based on the front and rear wheel target fluid pressures Ptf and Ptr (target value). The electromagnetic valve and the electric motor constituting the fluid unit HU are driven by the braking controller ECU, and the actual front and rear wheel brake fluid pressures Pwf and Pwr are controlled to approach and match the front and rear wheel target fluid pressures Ptf and Ptr.

The braking control device SC can separately control the front and rear wheel regenerative braking forces Fgf and Fgr between the front and rear wheels via the front and rear wheel regenerative braking devices KCf and KCr (in particular, the front and rear wheel generators GNf and GNr). In addition, the braking control device SC can separately control the brake fluid pressure Pw by the wheel cylinders CWf and CWr of the front and rear wheels. That is, the braking control device SC can separately control the front and rear wheel frictional braking forces Fmf and Fmr between the front and rear wheels.

In the regenerative coordination control of the braking control device SC, the front and rear wheel regenerative braking forces Fgf and Fgr and the front and rear wheel frictional braking forces Fmf and Fmr are adjusted so that the ratio Kq of the rear wheel required braking force Fqr to the front wheel required braking force Fqf (=Fqr/Fqf) is always constant. As a result, the ratio Kb of the rear wheel braking force Fbr to the front wheel braking force Fbf (=Fbr/Fbf) is always constant. Since the front and rear wheel braking force distribution is always optimized, the directional stability of the vehicle is improved during regenerative braking. In addition, since the front and rear wheel regenerative braking force Fgf and Fgr is used in priority up to the upper limit of the power regeneration amount (that is, the range of the maximum front and rear wheel regenerative braking forces Fxf and Fxr), the front and rear wheel regenerative braking device KCf and KCr sufficiently regenerates the kinetic energy of the vehicle. As described above, in the braking control device SC, both the vehicle stability and the energy regeneration are suitably achieved.

<Front and Rear Wheel Braking Force Distribution in Regenerative Coordination Control at Start of Braking>

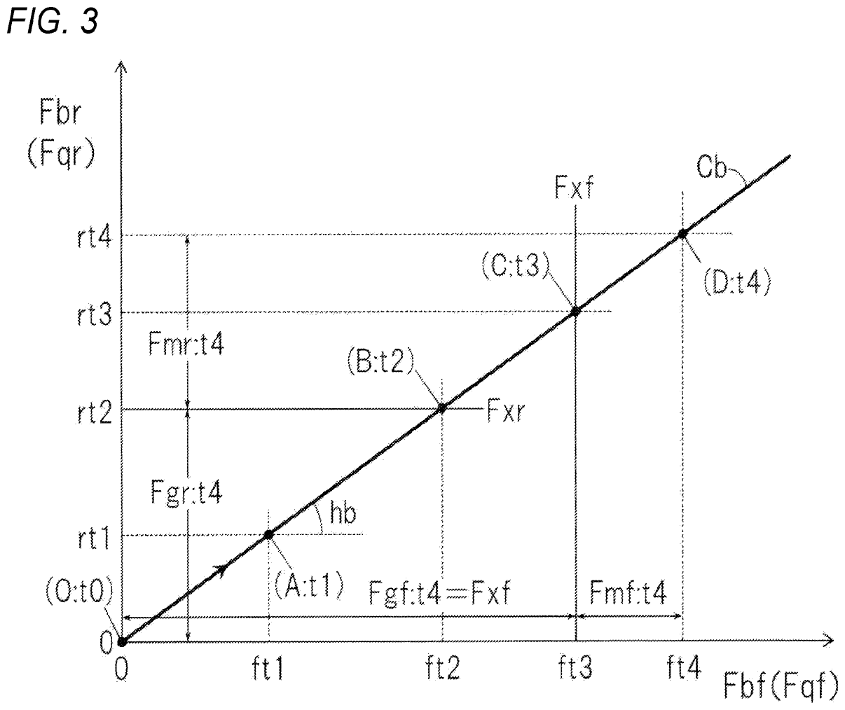

The distribution of the front and rear wheel braking forces in the regenerative coordination control at the start of braking will be described with reference to the characteristic diagram of FIG. 3. In the regenerative coordination control, a target value is calculated, and the actual value is controlled to match the target value. In the characteristic diagram, actual front and rear wheel braking forces Fbf and Fbr (actual values) are illustrated as the control results of the front and rear wheel required braking forces Fqf and For (target values).

First, various state amounts related to the braking force will be organized. The target value of the braking force acting on the entirety of the vehicle is the target vehicle body braking force Fv, and the actual value resulted in the control is the braking force Fb. Since the actual value Fb is generated on the front and rear wheels, the actual value related to the front wheel WHf (for two wheels) is the front wheel braking force Fbf, and the actual value related to the rear wheel WHr (for two wheels) is the rear wheel braking force Fbr. The target vehicle body braking force Fv is distributed to the braking forces of the front and rear wheels as the front and rear wheel required braking forces Fqf and Fqr. Therefore, the control results corresponding to the target values Fqf and Fqr are the actual front and rear wheel braking forces Fbf and Fbr. Furthermore, in the ratio of the rear wheel braking force to the front wheel braking force (also referred to as “distribution ratio”), the target value is the ratio Kq (=Fqr/Fqf), and the actual value is the ratio Kb (=Fbr/Fbf). Since the actual value is controlled to match the target value, the distribution ratio Kq and the distribution ratio Kb are substantially equal to each other and have a constant value hb (that is, “Kq=Kb=hb”).

The target values Fqf and Fqr are divided into target values by regenerative braking (target regenerative braking force) Fhf and Fhr and target values by friction braking (target friction braking force) (for example, braking by the frictional force when the friction member MS is pressed against the rotating member KT at the brake fluid pressure Pw) Fnf and Fnr. The control results corresponding to the target values Fhf and Fhr are the actual values Fgf and Fgr, and the control results corresponding to the target values Fnf and Fnr are the actual values Fmf and Fmr. Therefore, the target values have a relationship of “Fv=Fqf+Fqr, Fqf=Fhf+Fnf, Fr=Fhr+Fnr”, and the actual values have a relationship of “Fb=Fbf+Fbr, Fbf=Fgf+Fmf, Fbr=Fgr+Fmr”.

In the characteristic diagram (diagram representing the relationship of the rear wheel braking force Fbr with respect to the front wheel braking force Fbf), a situation in which the braking force is increased from the non-braking state is assumed. Specifically, at time point to, the target vehicle body braking force Fv starts to be increased from “0”, and then the target vehicle body braking force Fv is gradually increased. The transition of the front and rear wheel braking forces Fbf and Fbr in this situation is illustrated in the characteristic diagram. Although the maximum front and rear wheel regenerative braking forces Fxf and Fxr change according to the rotation speeds Ngf and Ngr of the front and rear wheel generators GNf and GNr, in consideration of complexity of description, a state in which both the maximum front and rear wheel regenerative braking forces Fxf and Fxr are limited to the front and rear wheel upper limit values fxf and fxr is selected in the calculation maps Zxf and Zxr (see the block X140) of FIG. 2. Here, the notation “:” in the drawing indicates a value at a corresponding time point. For example, “point (A:t1)” represents an operation point at the time point t1, and “Fmf:t4” represents a value of the front wheel friction braking force Fmf at the time point t4.

In the regenerative coordination control in the braking control device SC, the regenerative braking force Fg and the friction braking force Fm are adjusted so that the actual front and rear wheel braking forces Fbf and Fbr follow the reference property Cb. Specifically, in the reference property Cb, the ratio Kb (=Fbr/Fbf=Fqr/Fqf) of the rear wheel braking force Fbr to the front wheel braking force Fbf is set to a constant value hb. Therefore, in the characteristic diagram representing the relationship between the front wheel braking force Fbf and the rear wheel braking force Fbr, the reference property Cb is represented as a straight line passing through the original point (O) (that is, a point where “Fbf=Fbr=0”) and having an inclination hb (constant). Here, the inclination hb of the reference property Cb is set in advance on the basis of “pressure receiving area of front and rear wheel cylinders CWf, CWr”, “effective braking radius of rotating members KTf, KTr”, “friction coefficient of the friction material MS of the front and rear wheels”, and “effective radius of the wheel WH (tire)”. For example, the reference property Cb is set to be smaller than a so-called ideal distribution characteristic within a range of normal braking (in the region of the braking force excluding a region where the maximum value of the braking force is generated) so that the rear wheel WHr does not fall into the locked state ahead of the front wheel WHf. Note that, in the region where the maximum braking force is generated, the braking force distribution control (so-called EBD control) is executed based on the wheel speed Vw so that the deceleration slip of the rear wheel WHY does not become larger than the deceleration slip of the front wheel WHf. Hereinafter, the operation of the braking control device SC along with the transition of the time T will be described.

For each calculation cycle, the target vehicle body braking force Fv is determined according to the braking operation amount Ba and the calculation map Zfv. Then, the front and rear wheel required braking forces Fqf, Fqr are calculated to satisfy the conditions of “(Condition 1) The sum of the front wheel required braking force Fqf and the rear wheel required braking force For matches the target vehicle body braking force Fv” and “(Condition 2) The ratio Kg of the rear wheel required braking force For to the front wheel required braking force Fqf is a constant value hb”. Here, the front and rear wheel required braking forces Fqf, Fqr are target values (required value) corresponding to the actual front and rear wheel braking forces Fbf and Fbr. Furthermore, the maximum front and rear wheel regenerative braking forces Fxf and Fxr are acquired from the front and rear wheel regenerative braking devices KCf and KCr. As assumed above, that is “Fxf=fxf, Fxr=fxr”.

At the time point to, the operation of the braking operation member BP is started, and the braking operation amount Ba is increased from “0”. At the time point to, the operation of the regenerative coordination control is started from the original point (O:t0). At the time point t1, as indicated by the operation point (A:t1), the front and rear wheel required braking forces Fqf and Fqr are both less than the maximum front and rear wheel regenerative braking forces Fxf and Fxr. At the time point t2, the rear wheel required braking force Fqr (resultantly, the actual rear wheel braking force Fbr) reaches the maximum rear wheel regenerative braking force Fxr. Furthermore, at the time point t3, as indicated by the operation point (B:t2), the front wheel required braking force Fqf (resultantly, the actual front wheel braking force Fbf) reaches the maximum front wheel regenerative braking force Fxf.

Between the time point to and the time point t2 (that is, while the operation point transitions from the point (O: t0) to the point (B:t2)), the target vehicle body braking force Fv is relatively small, and the front and rear wheel required braking forces Fqf and For are both equal to or less than the maximum front and rear wheel regenerative braking forces Fxf and Fxr. Here, the maximum regenerative braking force Fx depends on the operation state of the regenerative braking device KC, and is a regenerative braking force that can be maximally generated. In the state of “Fqf≤Fxf, Fqr≤Fxr”, since the front and rear wheel regenerative braking devices KCf and KCr are sufficiently capable of generating the front and rear wheel regenerative braking forces Fgf and Fgr, the front and rear wheel target regenerative braking forces Fhf and Fhr are calculated as equal to the front and rear wheel required braking forces Fqf and For (that is, “Fhf=Fqf, Fhr=Fqr”). Since the generation of the friction braking force Fm is unnecessary, both the front and rear wheel target friction braking forces Fnf and Fnr are calculated as “0” (that is, “Fnf=Fnr=0”). As a result, the front and rear wheel required braking forces Fqf and Fqr are achieved (realized) as the actual front and rear wheel braking forces Fbf and Fbr only by the front and rear wheel regenerative braking forces Fgf and Fgr. At this time, the front and rear wheel frictional braking forces Fmf and Fmr remain “0”. Since condition 2 is satisfied with only regenerative braking, the operation point of the regenerative coordination control transitions along the reference property Cb.

Between the time point t2 and the time point t3 (that is, while the operation point transitions from the point (B: t2) to the point (C:t3)), the front wheel required braking force Fqf is equal to or less than the maximum front wheel regenerative braking force Fxf, but the rear wheel required braking force For is larger than the maximum rear wheel regenerative braking force Fxr. Therefore, it is necessary to generate the rear wheel friction braking force Fmr. That is, after the time point t2, the maximum rear wheel regenerative braking force Fxr is determined as the rear wheel target regenerative braking force Fhr, and the rear wheel target friction braking force Fnr is increased from “0” so that the deficiency with respect to the rear wheel required braking force Fqr (that is, “Fqr−Fxr”) is complemented (that is, “Fhr=Fxr, Fnr=Fqr−Fxr”). Accordingly, after the time point t2, the actual rear wheel friction braking force Fmr is increased from “0”. Note that, since the state in which the braking force requirement Fqf is equal to or less than the maximum regenerative braking force Fxf is still continued for the front wheel WHf, the front wheel target regenerative braking force Fhf is calculated as equal to the front wheel required braking force Fqf, and the front wheel target friction braking force Fnf remains “0” (that is, “Fhf=Fqf, Fnf=0”). Since condition 2 is satisfied when the rear wheel friction braking force Fmr is increased, the operation point of the regenerative coordination control transitions along the reference property Cb.

After the time point t3 (for example, during the transition from the operation point (C:t3) to the operation point (D:t4)), the front and rear wheel required braking forces Fqf and For are both larger than the maximum front and rear wheel regenerative braking forces Fxf and Fxr. Therefore, the front and rear wheel required braking forces Fqf and For are achieved (realized) by the front and rear wheel regenerative braking forces Fgf and Fgr and the front and rear wheel frictional braking force Fmf and Fmr. Specifically, the front and rear wheel target regenerative braking forces Fhf and Fhr are determined to be equal to the maximum front and rear wheel regenerative braking forces Fxf and Fxr (Fhf=Fxf, Fhr=Fxr). Then, the front and rear wheel target friction braking forces Fnf and Fnr are calculated as equal to the deficiency with respect to the front and rear wheel required braking forces Fqf and Fqr (that is, “Fqf−Fxf, Fqr−Fxr”) so that the deficiency is complemented (that is, “Fnf=Fqf−Fxf, Fnr=Fqr−Fxr”). For example, at the time point t4, the front wheel braking force Fbf is achieved as the sum of the front wheel regenerative braking force Fgf and the front wheel friction braking force Fmf (=Fgf:t4+Fmf: t4). In addition, the rear wheel braking force Fbr is achieved as the sum of the rear wheel regenerative braking force Fgr and the rear wheel friction braking force Fmr (=Fgr:t4+Fmr:t4). Similarly in this case, the relationship between the front wheel braking force Fbf and the rear wheel braking force Fbr is along the reference property Cb and does not deviate therefrom.

The achievement situation of the braking force Fb with respect to the transition of the time T will be summarized. When the braking is started, as the target vehicle body braking force Fv increases, the operation point of the regenerative coordination control transitions along the reference property Cb (straight line of the inclination hb) in the order of “(O:t0)→(A:t1)→(B:t2)→(C:t3)→(D:t4)”. The generation of the rear wheel regenerative braking force reaches the limit at the point (B:t2), and the generation of the front wheel regenerative braking force reaches the limit at the point (C:t3). Since it is sufficiently capable of generating the regenerative braking force between the time points to and t2, the front and rear wheel required braking forces Fqf and For are achieved only by the front and rear wheel regenerative braking forces Fgf and Fgr (that is, “Fbf=Fgf, Fbr=Fgr”). Since it is sufficiently capable of generating the front wheel regenerative braking force between the time points t2 and t3, the front wheel required braking force Fqf is achieved only by the front wheel regenerative braking force Fgf. However, since the generation of the rear wheel regenerative braking force has reached the limit, the rear wheel required braking force For is achieved by the rear wheel regenerative braking force Fgr and the rear wheel friction braking force Fmr (that is, “Fbf=Fgf, Fbr=Fgr+Fmr”). After the time point t3 when the generation of regenerative braking force in the front wheel and the rear wheel becomes incapable, the front and rear wheel required braking forces Fqf and For are achieved by the front and rear wheel regenerative braking forces Fgf and Fgr and the front and rear wheel frictional braking force Fmf and Fmr (that is, “Fbf=Fgf+Fmr, Fbr=Fgr+Fmr”).

As described above, in the regenerative coordination control in the braking control device SC, when the target vehicle body braking force Fv is gradually increased at the start of braking, the distribution of the front and rear wheel required braking forces Fqf and Fqr (resultantly, the actual front and rear wheel braking forces Fbf and Fbr) (that is, the ratio Kb of the rear wheel braking force Fbr to the front wheel braking force Fbf) is always maintained constant. That is, the braking control device SC always optimizes the distribution adjustment of the front and rear wheel braking forces Fbf and Fbr during regenerative braking. Therefore, the directional stability of the vehicle is not impaired by the relationship between the front and rear wheel braking forces Fbf and Fbr. In addition, in the braking control device SC, when “Fq≤Fx”, the target regenerative braking force Fh (resultantly, the actual regenerative braking force Fg) is prioritized over the target friction braking force Fn (resultantly, the actual friction braking force Fm). Therefore, the front and rear wheel regenerative braking devices KCf and KCr can recover the kinetic energy of the vehicle JV up to the regenerative power amount (that is, the regeneratable power amount) corresponding to the maximum front and rear wheel regenerative braking forces Fxf and Fxr. As a result, at the start of braking, the directional stability of the vehicle and the energy regeneration are balanced at a higher level, and both can be achieved.

<Front and Rear Wheel Braking Force Distribution in Switching Operation of Regenerative Coordination Control>

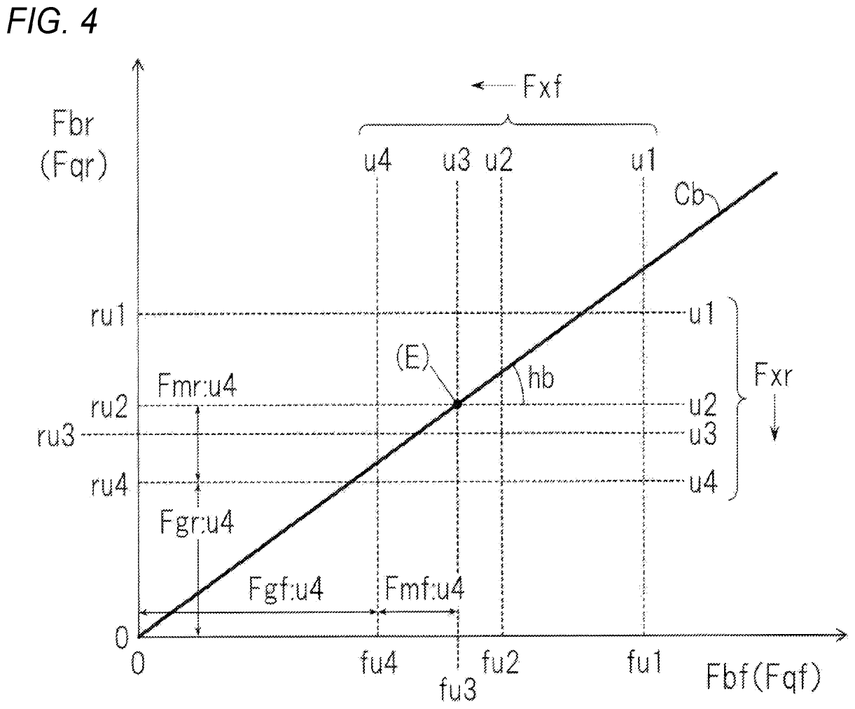

The distribution of the front and rear wheel braking forces Fbf and Fbr during the switching operation of the regenerative coordination control will be described with reference to the characteristic diagram of FIG. 4. “Switching operation” is to complement (compensate) the decrease of the regenerative braking force Fg by the friction braking force Fm when the vehicle body speed Vx decreases and the regenerative braking force Fg decreases. Therefore, by performing the switching operation, the generation source of the front and rear wheel braking forces Fbf and Fbr are gradually switched from the regenerative braking force Fg to the friction braking force Fm, so that necessary front and rear wheel braking forces Fbf and Fbr are secured. Note that, the state quantity related to the braking force is similar to that in the case of FIG. 3.

In the characteristic diagram, a situation is assumed in which the vehicle JV is sequentially decelerated and the switching operation is performed as the time T elapses in the order of “time point u1→time point u2→time point u3→time point u4” in a state where the vehicle body deceleration Gx (that is, the target vehicle body braking force Fv) is maintained constant. Therefore, in the characteristic diagram, since the target vehicle body braking force Fv is constant, the operation of the regenerative coordination control remains at the point (E) when the vehicle is decelerated. As the vehicle body speed Vx decreases, the front wheel generator rotation speed Ngf decreases. Therefore, as the time T elapses, the maximum front wheel regenerative braking force Fxf decreases in the order of “value fu1:u1→value fu2: u2→value fu3: u3→value fu4: u4”. Similarly, since the rear wheel generator rotation speed Ngr also decreases, the maximum rear wheel regenerative braking force Fxr decreases in the order of “value ru1: u1→value ru2: u2→value ru3: u3→value ru4: u4”.

At the time point u1, the front and rear wheel required braking forces Fqf and For (operation point (E)) are less than the maximum front and rear wheel regenerative braking forces Fxf (=fu1) and Fxr (=ru1). Since both the front and rear wheel regenerative braking devices KCf and KCr are sufficiently capable of generating the regenerative braking force, “Fhf=Fqf, Fhr=Fqr, Fnf=Fnr=0” is calculated. As a result, the front and rear wheel required braking forces Fqf and Fr are achieved (realized) only by the front and rear wheel regenerative braking forces Fgf and Fgr.

At the time point u2, the maximum rear wheel regenerative braking force Fxr (=ru2) matches the rear wheel required braking force Fqr. Since it is incapable of generating the rear wheel regenerative braking force after the time point u2, the rear wheel required braking force For is achieved (realized) by the rear wheel regenerative braking force Fgr and the rear wheel friction braking force Fmr. On the other hand, since the front wheel required braking force Fqf is less than the maximum front wheel regenerative braking force Fxf (=fu2) and it is capable of generating the front wheel regenerative braking force, the front wheel required braking force Fqf is achieved (realized) only by the front wheel regenerative braking force Fgf.

At the time point u3 when the time T elapses from the time point u2, the maximum front wheel regenerative braking force Fxf (=fu3) matches the front wheel required braking force Fqf. It is incapable of generating the front and rear wheel regenerative braking force after the time point u3, both the front and rear wheel required braking force Fqf and Fqr are achieved (realized) by the front and rear wheel regenerative braking force Fgf and Fgr and the front and rear wheel frictional braking force Fmf and Fmr. For example, at the time point u4, “Fhf=Fxf (=fu4), Fhr=Fxr (=ru4)” is calculated. Then, “Fnf=Fqf−Fxf, Fnr=Fqr−Fxr” is calculated so that the deficiency with respect to the front and rear wheel required braking forces Fqf and For is complemented by the front and rear wheel frictional braking force Fmf and Fmr. Accordingly, both “condition 1: Fv=Fbf+Fbr=(Fgf+Fmf)+(Fgr+Fmr)” and “condition 2: Kb=Fbr/Fbf=hb” are satisfied.

As described above, when the braking control device SC performs the switching operation between the regenerative braking force Fg and the friction braking force Fm, the distribution Kb (that is, the ratio of the rear wheel braking force Fbr to the front wheel braking force Fbf) of the front and rear wheel braking forces Fbf and Fbr is always maintained constant (value hb), so that the distribution adjustment of the front and rear wheel braking forces Fbf and Fbr is optimized. As a result, directional stability of the vehicle is improved. Furthermore, since the regenerative braking force Fg is prioritized over the friction braking force Fm in the braking control device SC, the front and rear wheel regenerative braking devices KCf and KCr can sufficiently recover the kinetic energy up to the regeneratable power amount (the power amount corresponding to the upper limit of the regenerative braking force Fx). That is, during the switching operation, the directional stability of the vehicle and the energy regeneration are balanced at a higher level, and both can be achieved.

### OTHER EMBODIMENTS

Hereinafter, other embodiments will be described. In other embodiments, the same effects as described above (optimization of front and rear wheel braking force distribution and achievement of vehicle stability and energy regeneration amount associated therewith) are achieved.

In the embodiment described above, at the generation limit of the regenerative braking force Fg, the braking force requirements Fqf and For reach the maximum rear wheel regenerative braking force Fxr before reaching the maximum front wheel regenerative braking force Fxf. Which regenerative braking device reaches the limit first depends on the magnitude (specification) of the regenerative capacity of the regenerative braking device. When the regenerative capacity of the front wheel regenerative braking device KCf is larger than the regenerative capacity of the rear wheel regenerative braking device KCr, as exemplified in the embodiment, the rear wheel regenerative braking force Fgr reaches the maximum rear wheel regenerative braking force Fxr before the front wheel regenerative braking force Fgf reaches the maximum front wheel regenerative braking force Fxf. On the other hand, when the regenerative capacity of the rear wheel regenerative braking device KCr is larger than the regenerative capacity of the front wheel regenerative braking device KCf, conversely, the front wheel regenerative braking force Fgf reaches the maximum front wheel regenerative braking force Fxf before the rear wheel regenerative braking force Fgr reaches the maximum rear wheel regenerative braking force Fxr. In any case, since the distribution ratios Kq (target value) and Kb (actual value) are maintained at the constant value hb by the braking control device SC, both improvement of the directional stability of the vehicle and securing of the energy regeneration amount are achieved.

In the embodiment above, the maximum front and rear wheel regenerative braking forces Fxf and Fxr (=Fx) are determined based on the front and rear wheel rotation speeds Ngf and Ngr (=Ng). At the time of regenerative braking, the front and rear wheel generators GNf and GNr are rotationally driven by the front wheel WHf and the rear wheel WHr. Therefore, instead of the front and rear wheel rotation speeds Ngf and Ngr, the rotation speeds of the rotating constituent members from the front and rear wheel generators GNf and GNr to the front wheel WHf and the rear wheel WHr can be adopted. For example, instead of the front and rear wheel rotation speeds Ngf and Ngr, the wheel speeds Vwf and Vwr (=Vw) of the front wheel WHf and the rear wheel WHr are adopted. Alternatively, the vehicle body speed Vx calculated based on the wheel speed Vw may also be adopted. That is, the maximum regenerative braking force Fx is determined (calculated) based on at least one of the generator rotation speed Ng, the wheel speed Vw, and the vehicle body speed Vx.

In the embodiment above, in the communication between the braking controller ECU and the front and rear wheel regenerative controllers EGf and EGr, the dimension of “force” is adopted as the physical quantity of the maximum regenerative braking force Fx (=Fxf, Fxr) and the target regenerative braking force Fh (=Fhf, Fhr). Since the specifications of the braking device SX, the braking control device SC and the regenerative braking device KC, and the state quantity (wheel speed Vw, vehicle body speed Vx, etc.) of the vehicle are known, other convertible physical quantities (for example, the torque amount and the power amount) may be adopted as the physical quantities of the maximum regenerative braking force Fx and the target regenerative braking force Fh. For example, the front and rear wheel power amount limits Rxf and Rxr (=Rx) are transmitted from the regeneration controller EG to the braking controller ECU as limit values (upper limit values) of the regeneratable power amount. Then, the power amount limit Rx is converted and calculated by the braking controller ECU, and the maximum regenerative braking force Fx can be determined. In addition, the target power amount Rh (=Rhf, Rhr) is calculated based on the target regenerative braking force Fh and transmitted to the regenerative controller EG (=EGf, EGr) by the braking controller ECU. Then, the actual regenerative power amount Rg (=Rgf, Rgr) is adjusted by the regenerative controller EG based on the target power amount Rh. As a result, the regenerative braking force Fg (=Fgf, Fgr) corresponding to the regenerative power amount Rg is generated. In any case, the regenerative braking force Fg corresponding to the target regenerative braking force Fh is generated.

In the embodiment above, the front-rear type configuration is adopted as the two-system brake fluid path. Alternatively, a diagonal type (also referred to as “X type”) braking system may also be adopted. In this case, as the fluid unit HU, a fluid unit capable of independently and individually controlling the brake fluid pressures Pw of all the wheel cylinders CW as described in JP 2008-006893 A is adopted.

In the embodiment above, a fluid pressure actuator (fluid unit HU) via the brake fluid BF is exemplified as the actuator that adjusts the braking force Fb of the wheel WH. Alternatively, an electric type that is driven by an electric motor can be adopted. The rotational power of the electric motor (different from the electric motor GN of the regenerative braking device KC) is converted into linear power by the electric actuator, and the friction member MS is pressed against the rotating member KT by the linear power. Therefore, the braking force is generated directly by the electric motor independent of the brake fluid pressure Pw. Furthermore, a combined type in which a fluid pressure actuator via the brake fluid BF is adopted for the front wheel WHf and an electric actuator is adopted for the rear wheel WHr is also acceptable.

In the embodiment above, the configuration of the disc type braking device (disc brake) is exemplified. In this case, the friction member MS is a brake pad, and the rotating member KT is a brake disc. Instead of the disc type braking device, a drum type braking device (drum brake) can be adopted. In the case of a drum brake, a brake drum is adopted instead of the brake caliper CP. In addition, the friction member MS is a brake shoe, and the rotating member KT is a brake drum.

<Summary of Braking Control Device SC>

The vehicle JV includes a braking control device SC. The braking control device SC includes an actuator HU (For example, a fluidic unit) and a controller ECU. The actuator HU driven by the controller ECU presses the friction member MS against the front wheel rotating member KTf to generate the front wheel friction braking force Fmf, and presses the friction member MS against the rear wheel rotating member KTr to generate the rear wheel friction braking force Fmr. Here, the front and rear wheel rotating members KTf and KTr are fixed to the front wheel WHf and the rear wheel WHr of the vehicle JV. The front wheel friction braking force Fmf and the rear wheel friction braking force Fmr are separately controlled by the controller ECU.

The vehicle JV includes front and rear wheel regenerative braking devices KCf and KCr controlled by the controller ECU. The front wheel regenerative braking force Fgf is generated on the front wheel WHf by the front wheel regenerative braking device KCf, and the rear wheel regenerative braking force Fgr is generated on the rear wheel WHr by the rear wheel regenerative braking device KCr. The front wheel regenerative braking force Fgf and the rear wheel regenerative braking force Fgr are separately controlled by the controller ECU. Therefore, the front wheel regenerative braking force Fgf, the rear wheel regenerative braking force Fgr, the front wheel friction braking force Fmf, and the rear wheel friction braking force Fmr are independently and individually adjusted.

In the controller ECU, the braking force required as a whole of the vehicle JV is calculated as the target vehicle body braking force Fv. Then, the front and rear wheel required braking forces Fqf, Fqr are calculated so that the sum of the front wheel required braking force Fqf and the rear wheel required braking force For matches the target vehicle body braking force Fv; and the ratio Kq of the rear wheel required braking force Fqr to the front wheel required braking force Fqf is a constant value hb. Specifically, as shown in Equation (1), when the ratio Kq of the rear wheel required braking force For to the front wheel required braking force Fqf is a constant value hb, the front wheel required braking force Fqf is calculated as a value obtained by dividing the “target vehicle body braking force Fv” by the “sum of the constant value hb and ‘1’” (that is, “Fqf=Fv/(1+hb)”). Further, the rear wheel required braking force For is calculated as a value obtained by dividing the “value obtained by multiplying the target vehicle body braking force Fv by the constant value hb” by “the sum of the constant value hb and ‘1’” (that is, “Fqr=Fv. hb/(1+hb)”).

The maximum generation value of the front and rear wheel regenerative braking force Fgf and Fgr, which can be generated by the front and rear wheel regenerative braking devices KCf and KCr are acquired as the maximum front and rear wheel regenerative braking force Fxf and Fxr by the controller ECU. The maximum front and rear wheel regenerative braking forces Fxf and Fxr are state quantities (variables) determined according to the operation states of the front and rear wheel regenerative braking devices KCf and KCr, and are regenerative braking forces that can be maximally generated by the front and rear wheel regenerative braking devices KCf and KCr, respectively. Here, the operation state of the regenerative braking device KC is expressed by a state quantity related to the rotation speeds of the rotating members from the wheel WH to the generator GN.

A front wheel limit determination is performed by the controller ECU to determine whether or not the front wheel required braking force Fqf is larger than the maximum front wheel regenerative braking force Fxf. When the front wheel required braking force Fqf is equal to or less than the maximum front wheel regenerative braking force Fxf and the front wheel limit determination is negative, since the front wheel regenerative braking force Fgf has not reached the limit, the front wheel required braking force Fqf is achieved only by the front wheel regenerative braking force Fgf. On the other hand, when the front wheel required braking force Fqf is larger than the maximum front wheel regenerative braking force Fxf and the front wheel limit determination is affirmative, since the front wheel regenerative braking force Fgf has reached the limit, the front wheel required braking force Fqf is achieved by both the front wheel regenerative braking force Fgf and the front wheel friction braking force Fmf.

Similarly, in the controller ECU, a rear wheel limit determination is performed to determine whether or not the rear wheel required braking force For is larger than the maximum rear wheel regenerative braking force Fxr. When the rear wheel required braking force For is equal to or less than the maximum rear wheel regenerative braking force Fxr and the rear wheel limit determination is negative, since the rear wheel regenerative braking force Fgr has not reached the limit, the rear wheel required braking force For is achieved only by the rear wheel regenerative braking force Fgr. On the other hand, when the rear wheel required braking force Fqr is larger than the maximum rear wheel regenerative braking force Fxr and the rear wheel limit determination is affirmative, since the rear wheel regenerative braking force Fgr has reached the limit, the rear wheel required braking force For is achieved by both the rear wheel regenerative braking force Fgr and the rear wheel friction braking force Fmr.

The relationship between the front and rear wheel required braking forces Fqf and Fqr (that is, the distribution ratio Kg) is determined to be always constant by the braking control device SC, and as a result, the relationship between the actual front and rear wheel braking forces Fbf and Fbr (that is, the distribution ratio Kb) is maintained constant. Since the distribution of the front and rear wheel braking forces Fbf and Fbr is always optimized, the vehicle stability is improved. Furthermore, the front wheel limit determination and the rear wheel limit determination are separately performed, and kinetic energy is recovered up to the limit of the power amount that can be regenerated by the front and rear wheel regenerative braking devices KCf and KCr. Therefore, both vehicle stability and energy regeneration can be achieved at a high level at the start of braking when the target vehicle body braking force Fv is gradually increased, and at the time of switching operation that transitions regenerative braking to friction braking.

1. A braking control device for a vehicle applied to a vehicle including front and rear wheel regenerative braking devices that generate front and rear wheel regenerative braking forces in a front wheel and a rear wheel, the braking control device comprising:
an actuator that generates front and rear wheel frictional braking forces in the front wheel and the rear wheel; and
a controller that controls the front and rear wheel regenerative braking devices and the actuator, wherein
the controller
calculates a braking force required by a whole of the vehicle as a target vehicle body braking force,
calculates front and rear wheel required braking forces so that, a sum of the front wheel required braking force and the rear wheel required braking force matches the target vehicle body braking force, and a ratio of the rear wheel required braking force to the front wheel required braking force is constant,
acquires maximum values of the front and rear wheel regenerative braking forces that can be generated and are determined in operating states of front and rear wheel regenerative braking devices as maximum front and rear wheel regenerative braking force,
achieves the front wheel required braking force by only the front wheel regenerative braking force when the front wheel required braking force is equal to or less than the maximum front wheel regenerative braking force, and by the front wheel regenerative braking force and the front wheel friction braking force when the front wheel required braking force is larger than the maximum front wheel regenerative braking force,
achieves the rear wheel required braking force by only the rear wheel regenerative braking force when the rear wheel required braking force is equal to or less than the maximum rear wheel regenerative braking force, and by the rear wheel regenerative braking force and the rear wheel friction braking force when the rear wheel required braking force is larger than the maximum rear wheel regenerative braking force.
